(19) United States
(12) Patent Application Publication
(10) Pub. No.: US 2009/0246363 A1
(43) Pub. Date: Oct. 1, 2009

(54) METHOD FOR REDUCING THE ICE, SNOW AND DUST ADHESION TO A SURFACE

(76) Inventor: Rock R. Kaiser, Greencastle, IN (US)

Correspondence Address: NALCO COMPANY, 1601 W. DIEHL ROAD, NAPERVILLE, IL, 60563-1198, US

(21) Appl. No.: 12/060,294

(22) Filed: Apr. 1, 2008

(51) Int. Cl. C09K 3/18

(52) U.S. Cl. 427/136

(57) ABSTRACT

The invention pertains to the pre treating of a surface to limit the adhesion of ice, snow and/or dust to said surface. The basis for the method is the use of a recycled brine solution as a pretreatment spray on the surface exemplified by an asphalt or concrete roadway. The current invention allows for the pretreatment of the surface that allows the reduce use of salt and other methods to clear the surface.

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

This invention relates to the use of the spent softener high-strength brine as channeled to facilities for use as a pre-ice, pre-snow and dust suppression composition to treat a surface. In reference to its applications on a road it is estimated that approximately 40 gallons of liquid sodium chloride is required for every lane mile of road as a preventative when freezing conditions or snow is predicted. This composition can be reduce by a significant amount because a blend of calcium, magnesium and sodium chloride is more desirable as calcium and magnesium chloride are much safer for the environment than concentrated sodium chloride.

### BACKGROUND

The invention described here pertains to the pre-treating of a surface to limit the adhesion of ice, snow and dust to said surface. The basis for the method is the use of a recycled brine solution as a pretreatment spray on the surface exemplified by an asphalt or concrete roadway.

The BrineCycle concept was developed as an alternative for the pure salt brine currently used by the Department of Transportation (DOT) for pretreatment of surfaces prior to (typically 24 to 48 hours) a frozen precipitation event. The current practice is for the DOT to dissolve part of their salt stores in water to saturation (approximately 26% sodium chloride). This salt brine is then applied to the surfaces at a rate of approximately 40-gallons/road lane mile. This material, being pure salt brine, is corrosive to roadbeds, and harmful to roadside vegetation.

BrineCycle is the use of the highest salt content waste stream from a sodium zeolite water softener instead of the currently used salt brine to pre-treat surfaces prior to a frozen precipitation event. This waste stream, currently discharged to sewer, was analyzed in December 2005 to a freeze point of 4° F. At 30 salometer degrees this material is typically an 8% sodium, magnesium and calcium salt solution. The lower sodium concentration is less corrosive to roadbeds, and roadside vegetation. The combination of sodium, calcium and magnesium chloride results in a lower freeze point, at a more dilute concentration, then pure sodium chloride due to the combination of the three different inorganic salts in solution.

### SUMMARY

The current invention describes the following key aspects:
1. It is an advantage of the invention to provide an easier clearing of a surface of ice and snow.
2. It is an advantage of the invention to provide a recyclable use for a byproduct of another process.
3. It is an advantage of the invention to provide a reduced use of salt on the road surface.
4. Provides a method for uninterrupted improved road conditions in bad weather conditions.
5. It is an advantage of the invention to provide a more dilute treatment solution to protect roadside vegetation.

### DETAILED DESCRIPTION

The current invention is a method for pre-treating a surface where a brine solution is applied to a surface prior to the contact with ice, snow and/or dust allowing for the easier removal from the surface of said ice, snow and/or dust. The brine is spent softener brine which may be spent softener high-strength brine. The method is ideal for use on an asphalt covered or a concrete covered surface which may be a roadway and/or a metal surface.

The current invention is also includes a method for pre-treating a surface where a brine is collected from a water softening system and delivered to a location for application to a surface prior to the surface coming in contact with ice, snow and/or dust allowing for the easier removal from the surface of said ice, snow and/or dust.

### EXAMPLES

The foregoing may be better understood by reference to the following examples, which are intended to illustrate methods for carrying out the invention and are not intended to limit the scope of the invention.

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

In the winter of 2007/2008, INDOT performed two trials of the BrineCycle material. The first trial was to sidewalks at the INDOT Seymour District offices. This trial was successful based upon INDOT evaluation criteria. In March 2008, INDOT completed their second trial that was more extensive. In this trial the DOT treated their parking lot and evaluated the material's effectiveness. Follow-up conversations with INDOT indicated that the BrineCycle material performed as well as pure salt brine. Both trials used a total of 275 gallons of high strength softener reject.

We claim:

1. A method for pre-treating a surface where a brine solution is applied to a surface prior to the contact with ice, snow and/or dust allowing for the easier removal from the surface of said ice, snow and/or dust.

2. The method of claim 1 wherein the brine is spent softener brine.

3. The method of claim 1 wherein the brine is spent softener high-strength brine.

4. The method of claim 1 wherein the surface is an asphalt covered surface.

5. The method of claim 4 wherein the asphalt covered surface is a roadway.

6. The method of claim 1 wherein the surface is a concrete covered surface.

7. The method of claim 1 wherein the concrete covered surface is a roadway.

8. The method of claim 1 wherein the surface is a metal surface.

9. A method for pre-treating a surface where a brine is collected from a water softening system and delivered to a location for application to a surface prior to the surface coming in contact with ice, snow and/or dust allowing for the easier removal from the surface of said ice, snow and/or dust.

10. The method of claim 9 wherein the brine is spent softener high-strength brine.

11. The method of claim 9 wherein the surface is an asphalt covered surface.

12. The method of claim 11 wherein the asphalt covered surface is a roadway.

13. The method of claim 9 wherein the surface is a concrete covered surface.

14. The method of claim 9 wherein the concrete covered surface is a roadway.

15. The method of claim 9 wherein the surface is a metal surface.
